(19) United States
(12) Patent Application Publication
(10) Pub. No.: US 2025/0324282 A1
(43) Pub. Date: Oct. 16, 2025

(54) RADIO TRANSMISSION SYSTEM

(71) Applicant: AGC Inc., Tokyo (JP)

(72) Inventor: Kumiko KAMBARA, Tokyo (JP)

(73) Assignee: AGC Inc., Tokyo (JP)

(21) Appl. No.: 19/250,555

(22) Filed: Jun. 26, 2025

Related U.S. Application Data
(63) Continuation of application No. PCT/JP2023/023724, filed on Jun. 27, 2023.

(30) Foreign Application Priority Data
Dec. 27, 2022 (JP) 2022-210450

(51) Int. Cl. H04W 16/26

(52) U.S. Cl. CPC H04W 16/26

(57) ABSTRACT

A radio transmission system capable of achieving both the improvement of a radio-wave propagation environment and the suppression of the emission of radio waves to the outside of the intended space is provided. A radio transmission system comprises: a base station configured to perform radio communication in a predetermined frequency band selected from frequencies from 1 GHz to 300 GHz; and an electromagnetic-wave reflecting apparatus disposed in a communication area of the base station and including a reflecting panel configured to reflect an electromagnetic wave in the predetermined frequency band, wherein the electromagnetic wave emitted from the base station impinges at a position lower than a position of an uppermost portion of a reflection surface of the reflecting panel, and the electromagnetic-wave reflecting apparatus reflects the electromagnetic wave incident on the reflecting panel downward with respect to the incident position.

### INCORPORATION BY REFERENCE

This application is based upon and claims the benefit of priority from Japanese patent application No. 2022-210450, filed on Dec. 27, 2022, and PCT application No. PCT/JP2023/023724 filed on Jun. 27, 2023, the disclosure of which is incorporated herein in its entirety by reference.

### BACKGROUND

Radio base stations have been increasingly installed indoors and outdoors in order to automate manufacturing processes and office work, implement control and management by remote control and AI (Artificial Intelligence), and realize automated driving. Radio base stations have also been installed indoors such as factories, plants, offices, and commercial facilities, and outdoors such as highways and railway tracks, as well as other indoor or outdoor situations such as medical sites and event venues.

In 5th generation mobile communication standards (hereinafter referred to as “5G”), frequency bands at 6 GHz or lower called “sub-6” and 28 GHz bands which are classified as millimeter-wave bands are provided. In the next-generation 6G mobile communications standards, it is expected that the frequency band will be extended to sub-terahertz bands. By using such high-frequency bands, the communication bandwidth is greatly extended, so that a large amount of data can be communicated with a small delay. A configuration in which electromagnetic reflecting apparatuses are arranged along at least a part of a production line of a factory has been proposed (see, for example, International Patent Publication No. WO2021/199504).

### SUMMARY

When local 5G radio waves are applied indoors or outdoors, there are usually a large number of structures and moving objects in the place where a base station is installed, so that blind zones which radio waves hardly reach because they are blocked by these structures and objects are formed. It is difficult to eliminate such blind zones by simply increasing the number of base stations despite the increase in the cost. It is necessary to consider how to increase the efficiency of the use of radio waves with the minimum number of additional base stations. Meanwhile, when local 5G radio waves reach outside the intended area, they may interfere with other commercial radio waves. It is required to achieve both the improvement in regard to blind zones and the suppression of the emission (i.e., undesired emission) of radio waves to the outside.

An object of the present invention is to provide a radio transmission system capable of achieving both the improvement of a radio-wave environment and the suppression of the emission of radio waves to the outside of the intended space.

In an embodiment, a radio transmission system comprises:
a base station configured to perform radio communication in a predetermined frequency band selected from frequencies from 1 GHz to 300 GHz; and
an electromagnetic-wave reflecting apparatus disposed in a communication area of the base station and including a reflecting panel configured to reflect an electromagnetic wave in the predetermined frequency band, wherein
the electromagnetic wave emitted from the base station impinges at a position lower than a position of an uppermost portion of a reflection surface of the reflecting panel, and
the electromagnetic-wave reflecting apparatus reflects the electromagnetic wave incident on the reflecting panel downward with respect to the incident position.

A radio transmission system capable of achieving both the improvement of a radio-wave environment and the suppression of the emission of radio waves to the outside of the intended space is provided.

The above and other objects, features and advantages of the present disclosure will become more fully understood from the detailed description given hereinbelow and the accompanying drawings.

### BRIEF DESCRIPTION OF DRAWINGS

FIG. 1A is a schematic diagram showing an example of a configuration of a radio transmission system according to an embodiment;

FIG. 1B is a schematic diagram showing another example of a configuration of a radio transmission system;

FIG. 1C is a schematic diagram showing yet another example of a configuration of a radio transmission system;

FIG. 2 is a schematic diagram of an electromagnetic-wave reflecting apparatus used in a radio transmission system;

FIG. 3 is a schematic diagram of an electromagnetic-wave reflecting fence to which an electromagnetic-wave reflecting apparatus is connected;

FIG. 4 is a schematic diagram showing a modified example of an electromagnetic-wave reflecting fence;

FIG. 5 is an example of a structure on a horizontal cross section of a frame taken along a line A-A shown in FIG. 4;

FIG. 6 is a top view of a connection portion C shown in FIG. 4;

FIG. 7 shows another example of a connection of an electromagnetic-wave reflecting fence;

FIG. 8 shows yet another example of an arrangement of an electromagnetic-wave reflecting fence;

FIG. 9 is a schematic plan diagram showing another example of an arrangement of electromagnetic-wave reflecting fences; and

FIG. 10 is a schematic plan view showing an example of an arrangement of electromagnetic-wave reflecting apparatuses.

### DESCRIPTION OF EMBODIMENTS

In an embodiment, a blind zone is improved (i.e., eliminated or reduced) and the emission (i.e., undesired emission) of radio waves to the outside is suppressed in a radio transmission system used indoors or outdoors by using an electromagnetic-wave reflecting apparatus(es). In this specification, the term “blind zone” refers to a zone in which the received power is lowered by 10 dB or more due to the presence of a shielding object(s) compared with the surrounding receiving environment in which there is no shielding object. In general, electromagnetic waves having frequencies 3 THz or lower are called radio waves. However, in this specification, communication waves transmitted from a base station are called “radio waves”, and electromagnetic waves in general are called “electromagnetic waves”.

The blind zone includes not only a two-dimensional area but also a three-dimensional space. When there is a production apparatus, a sensor, or a mobile communication terminal equipped with a radio communication function in the blind zone, it becomes difficult to transmit/receive signals to/from the base station. Therefore, the radio-wave environment is improved by introducing an electromagnetic-wave reflecting apparatus(es) and thereby reducing blind zones. By devising the positional relationship between the electromagnetic-wave reflecting apparatus(es) and the base station, and the arrangement/configuration thereof, the emission of radio waves from the area where a radio wave having a strong straight-traveling property is used is suppressed.

A configuration of a radio transmission system according to an embodiment will be described hereinafter with reference to the drawings. The embodiment described below is merely an example to embody the technical concept of the present invention and is not intended to limit the scope of the present invention. The size, the position relationship, and the like of each member shown in the drawings may be exaggerated as appropriate in order to facilitate the understanding of the invention. In the following description, the same components or functions are assigned the same names or symbols, and redundant descriptions thereof may be omitted.

### <Radio Transmission System>

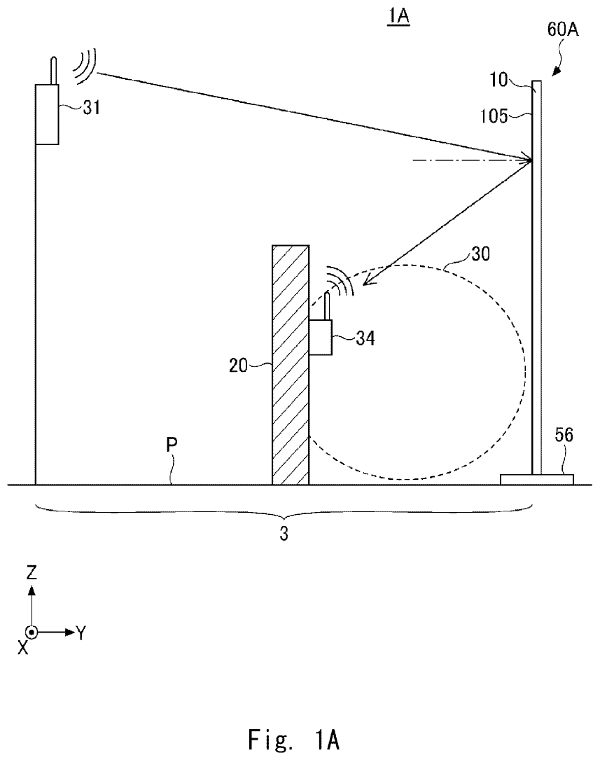

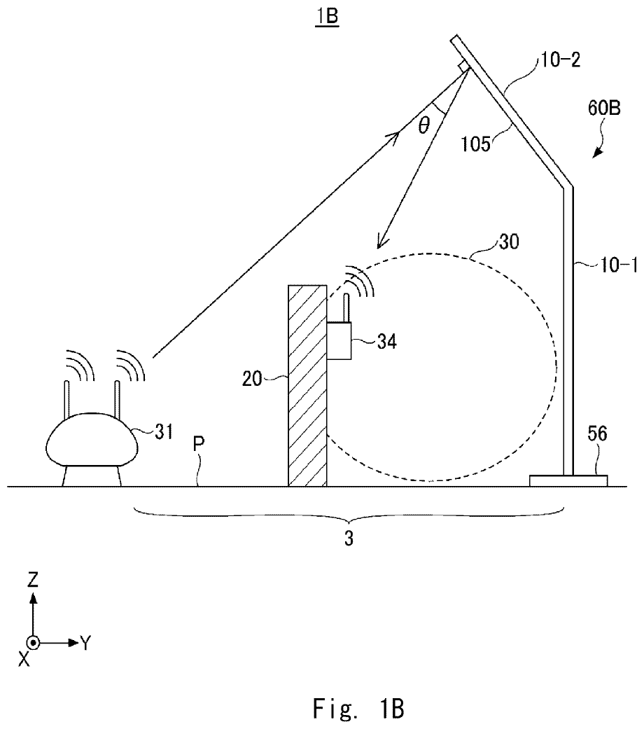

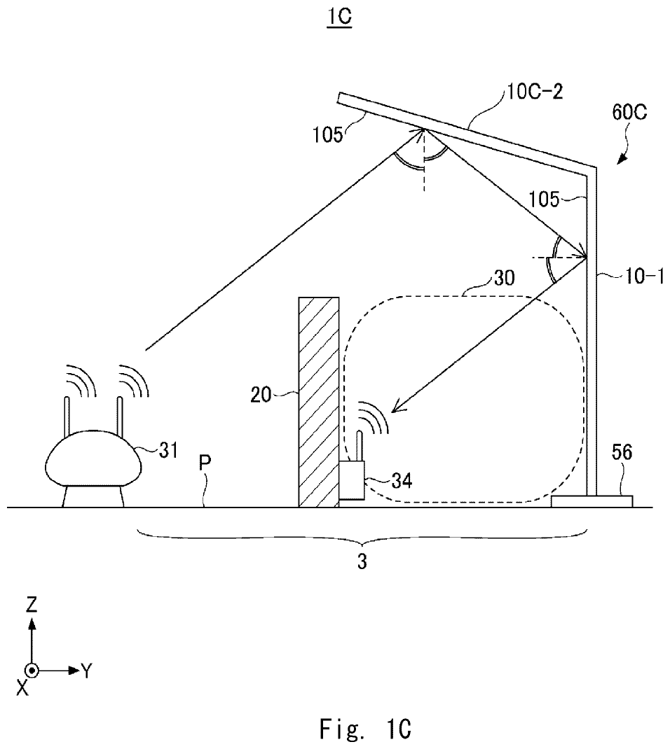

FIG. 1A is a schematic diagram of a radio transmission system 1A according to an embodiment. The radio transmission system 1A is installed indoors or outdoors, and supports radio communication in a predetermined frequency band selected from a range of at least from 1 GHz to 170 GHz, preferably from 1 GHz to 300 GHz. The radio transmission system 1A includes a base station 31 that transmits/receives signals in a predetermined frequency band included in the above-described frequency range, and an electromagnetic-wave reflecting apparatus 60A that reflects electromagnetic waves in the frequency band used by the base station 31. In the coordinate system shown in FIG. 1A, the installation plane P on which the electromagnetic-wave reflecting apparatus 60A is placed is defined as an XY plane, and the height direction orthogonal to the XY plane is defined as a Z direction.

The antenna of the base station 31 has directivity and a gain that are selected according to the size, the shape, the use, and the like of the space in which the base station 31 is introduced. As an example, the base station 31 includes an antenna of which the maximum gain is 5 dBi or higher and 30 dBi or lower. An electromagnetic wave emitted from the base station 31 impinges at a position lower than the highest part of the reflection surface 105 of the electromagnetic-wave reflecting apparatus 60A. That is, the cross section of the beam of an electromagnetic wave emitted from the base station 31 incident on the reflection surface 105 is located below the uppermost end of the reflection surface 105. The cross section of the beam incident on the reflection surface 105 may be expressed as the width of the beam when the electromagnetic wave emitted from the base station 31 is incident on the reflection surface 105 with power equal to or higher than a half of its maximum value (e.g., −3 dB). This beam width is referred to as “3 dB beam width”. When the position of the cross section of the beam incident on the electromagnetic-wave reflecting apparatus 60A is lower than the uppermost end of the reflection surface and the incident beam is reflected downward with respect to the incident position, the position of the antenna itself of the base station 31 may be higher than the uppermost end of the electromagnetic-wave reflecting apparatus 60A or may be lower than the uppermost end thereof.

In the environment in which the base station 31 is used, there are structures 20 such as shelves, racks, and pillars. In FIG. 1A, the place where the base station 31 is introduced is, for example, a process line 3 along which there are production machines. The production machine used in the process line 3 includes a radio terminal 34 that communicates with the base station 31, and the production machine itself can be a structure 20 that blocks radio waves emitted from the base station 31. An area behind the structure 20 as viewed from the antenna of the base station 31 is an NLOS (Non-Line-of-Sight) blind zone 30. In the blind zone 30, the received power is lowered by 10 dB or more compared with the surrounding receiving environment that is not shielded by the structure 20. When the radio terminal 34 is located in the blind zone 30, it cannot transmit/receive signals to/from the base station 31. Examples of the radio terminal 34 include a mobile terminal such as a smartphone and a sensor device fixed at a predetermined position.

The electromagnetic-wave reflecting apparatus 60A improves the radio-wave environment by sending the radio wave emitted from the base station 31 to the blind zone 30. The electromagnetic-wave reflecting apparatus 60 includes a reflecting panel 10 that reflects electromagnetic waves having the frequency used by the base station 31. The electromagnetic-wave reflecting apparatus 60A may have legs 56 so as to stand alone on the installation plane P. In the example shown in FIG. 1A, the reflecting panel 10 is supported on the legs 56 at an angle substantially perpendicular to the installation plane P. The term “substantially perpendicular” includes a range of 90°±10° in which the reflecting panel or the like can stably stand on the installation plane P. The legs 56 may be equipped with casters with locks, so that the electromagnetic-wave reflecting apparatus 60A can be moved and installed in a desired place. The electromagnetic-wave reflecting apparatus 60A may be mounted on a wall or a ceiling without using the legs 56.

The reflection surface 105 of the reflecting panel 10 of the electromagnetic-wave reflecting apparatus 60A includes at least one of a specular reflection surface and a meta-surface, which is an artificial reflection surface of which the reflection characteristic is controlled. The meta-surface is formed of a periodic structure or pattern that is finer than the wavelength and is designed so as to reflect radio waves in a desired direction. Specifically, the reflection surface of the meta-surface is formed by forming a ground layer on one of the surfaces of a dielectric layer and a periodic pattern which is made of a conductive material and designed for a predetermined reflection characteristic on the other surface of the dielectric layer. The meta-surface can reflect an electromagnetic wave at a reflection angle different from the incident angle. The reflection at an angle different from the incident angle includes controlled diffusion and scattering, and they may be correctively referred to as non-specular reflection.

For example, the structure 20 is a metal cabinet having a height of about 1 m, and a radio terminal 34 embedded in an IoT (Internet of Things) sensor is located behind the cabinet as viewed from the base station 31. The reflecting panel 10 of the electromagnetic-wave reflecting apparatus 60A includes a non-specular reflection surface on at least a part of the reflection surface 105, and reflects an electromagnetic wave incident thereon toward the blind zone 30 at an angle different from the incident angle. In the example shown in the drawing, the electromagnetic-wave reflecting apparatus 60A reflects an electromagnetic wave incident on the reflecting panel 10 downward with respect to the incident position at an angle different from the incident angle. In general, a meta-surface has a fine periodic pattern designed so as to control the reflection direction in the horizontal plane parallel to the XY plane. However, by designing the periodic pattern so as to control the reflection angle in the vertical (XZ) plane, the reflection configuration shown in FIG. 1A can be realized. The meta-surface may be designed so as to reflect an electromagnetic wave incident perpendicular thereto at a reflection angle larger than 0° and smaller than 90°.

The electromagnetic-wave reflecting apparatus 60A reflects the radio wave emitted from the base station 31 toward the blind zone 30 and suppresses the emission (i.e., undesired emission) of radio waves to the outside of the process line 3 between the base station 31 and the radio terminal 34. The radio transmission system 1A makes it possible to improve the radio-wave environment and suppress the emission of radio waves to the outside of the intended space.

FIG. 1B is a schematic diagram of a radio transmission system 1B. The radio transmission system 1B includes a base station 31 and an electromagnetic-wave reflecting apparatus 60B that reflects electromagnetic waves in a frequency band used by the base station 31. The electromagnetic-wave reflecting apparatus 60B includes a reflecting panel 10-1 that stands substantially perpendicular to the installation plane P, and a reflecting panel 10-2 that is inclined with respect to the installation plane P. The term “substantially perpendicular” includes a range of 90°±10° as described above. The reflecting panel 10-2 is inclined from the perpendicular line of the installation plane P toward the base station 31, and its reflection surface 105 faces obliquely downward.

An electromagnetic wave emitted from the base station 31 impinges on the reflecting panel 10-2 in such a manner that the cross section of the beam of the electromagnetic wave is located lower than the highest part of the reflection surface 105 of the electromagnetic-wave reflecting apparatus 60B, i.e., the highest part of the reflection surface 105 of the reflecting panel 10-2. A metal rack having a height of about 1.5 m is placed as a structure 20 in the environment in which the base station 31 is used. An area behind the rack as viewed from the base station 31 is a blind zone 30, and a radio terminal 34 is located in this blind zone 30.

A radio wave emitted from the base station 31 is reflected by the reflection surface 105 of the reflecting panel 10-2 and received by the radio terminal 34. The reflecting panel 10 of the electromagnetic-wave reflecting apparatus 60B has a non-specular reflection surface on at least a part of the reflection surface 105, and reflects an electromagnetic wave incident thereon toward the blind zone 30 at an angle different from the incident angle. The reflection surface 105 is formed of a periodic pattern, a mesh pattern, a geometric pattern, or the like formed of a transparent conductive material or a metallic material. In the non-specular reflection part of the reflection surface 105, the size, the shape, the interval, and the like of the periodic pattern are designed so that a desired reflection characteristic is obtained.

The electromagnetic-wave reflecting apparatus 60B reflects the radio wave emitted from the base station 31 toward the blind zone 30 and suppresses the emission of radio waves to the outside of the process line 3 between the base station 31 and the radio terminal 34. The radio transmission system 1B makes it possible to improve the radio-wave environment and suppress the emission of radio waves to the outside of the intended space.

FIG. 1C is a schematic diagram of a radio transmission system 1C. The radio transmission system 1C includes a base station 31 and an electromagnetic-wave reflecting apparatus 60C that reflects electromagnetic waves in a frequency band used by the base station 31. The electromagnetic-wave reflecting apparatus 60C includes a reflecting panel 10-1 that stands substantially perpendicular to the installation plane P, and a reflecting panel 10C-2 that is inclined with respect to the installation plane P.

An electromagnetic wave emitted from the base station 31 impinges on the reflecting panel 10C-2 in such a manner that the cross section of the beam of the electromagnetic wave is located lower than the highest part of the reflection surface 105 of the electromagnetic-wave reflecting apparatus 60C, i.e., the highest part of the reflection surface 105C of the reflecting panel 10C-2. A metal rack having a height of about 1.5 m is placed as a structure 20 in the environment in which the base station 31 is used. An area behind the rack as viewed from the base station 31 is a blind zone 30, and a radio terminal 34 is located in this blind zone 30.

In the example shown in FIG. 1C, the specular reflection by the electromagnetic-wave reflecting apparatus 60C is used. A radio wave emitted from the base station 31 is specularly reflected by the reflection surface 105C of the reflecting panel 10C-2 and then is incident on the reflecting panel 10-1. The incident wave is reflected in the direction toward the blind zone 30 by the reflecting panel 10-1 and received by the radio terminal 34. In general, a specular reflection surface can achieve reflection efficiency close to 100%, so that the reflected wave reflected by the reflecting panel 10C-2 has a sufficient reflection strength. The reflected wave re-reflected by the reflecting panel 10-1 is also received by the radio terminal 34 with sufficient power.

The electromagnetic-wave reflecting apparatus 60C reflects the radio wave emitted from the base station 31 toward the blind zone 30 and suppresses the emission of radio waves to the outside of the process line 3 between the base station 31 and the radio terminal 34. The radio transmission system 1C makes it possible to improve the radio-wave environment and suppress the emission of radio waves to the outside of the intended space.

### <Electromagnetic-Wave Reflecting Apparatus and Electromagnetic-Wave Reflecting Fence>

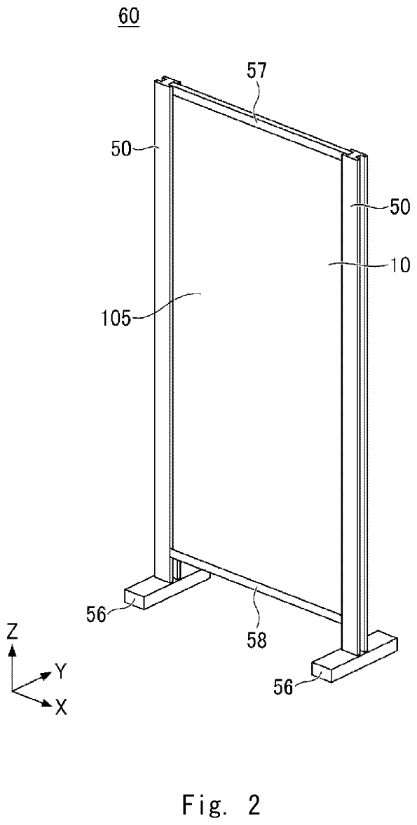

FIG. 2 is a schematic diagram of an electromagnetic-wave reflecting apparatus 60. The electromagnetic-wave reflecting apparatus includes a reflecting panel 10 and frames 50 for holding the reflecting panel. The width or lateral direction of the reflecting panel 10 is defined as an X direction; the thickness direction is defined as a Y direction; and the height or longitudinal direction is defined as a Z direction. The frames 50 hold both ends of the reflecting panel 10 along the height direction. The frames 50 contributes, in addition to stably holding both ends of the reflecting panel 10, to the safety of the transportation of the reflecting panel 10 and the reinforcement of the mechanical strength thereof. Further, in the case where a plurality of reflecting panels 10 are connected to one another and used together, the frames 50 may have a function and a configuration for electrically connecting adjacent reflecting panels 10 to each other and thereby making their reflection potentials continuous.

The electromagnetic-wave reflecting apparatus 60 may include a top frame 57 for holding the upper end of the reflecting panel 10 in the height direction, and a bottom frame 58 for holding the lower end thereof. The frames 50 may be referred to as side frames because of the positional relationship with the top frame 57 and the bottom frame 58. Legs 56 may be provided in the electromagnetic-wave reflecting apparatus 60, so that the electromagnetic-wave reflecting apparatus 60 may stand alone.

The reflecting panel 10 reflects electromagnetic waves in a predetermined frequency band selected from frequencies from 1 GHz to 300 GHz. The reflection surface 105 of the reflecting panel 10 includes at least one of a non-specular reflection surface including a meta-surface and a specular reflection surface. The reflection surface 105 is formed of a periodic pattern, a mesh pattern, a geometric pattern, or the like formed of a transparent conductive material or a metallic material having a good conductivity. When the meta-surface is formed of a periodic conductive pattern, the pattern is designed so that a desired reflection characteristic is obtained.

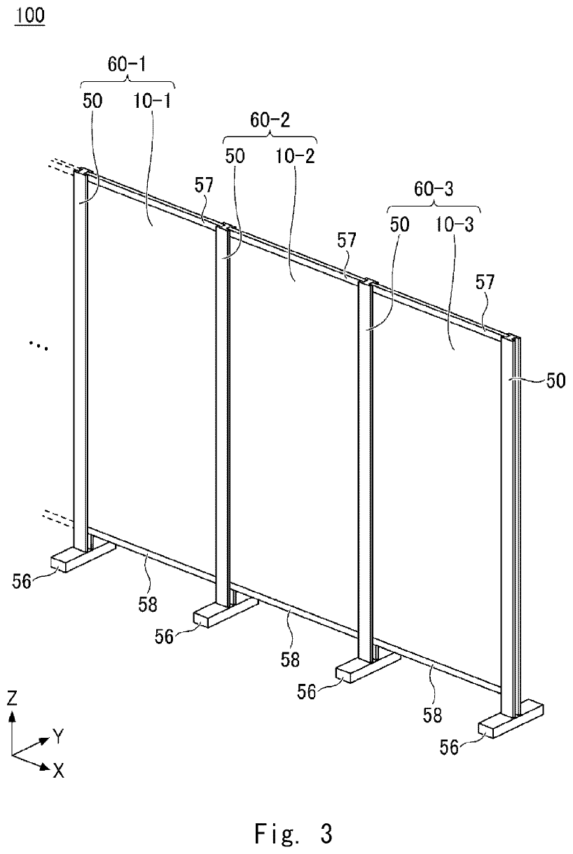

FIG. 3 is a schematic diagram of an electromagnetic-wave reflecting fence 100. The electromagnetic-wave reflecting fence 100 is formed by connecting a plurality of electromagnetic-wave reflecting apparatuses 60-1, 60-2 and 60-3 to one another. Reflecting panels 10-1, 10-2 and 10-3 of the electromagnetic-wave reflecting apparatuses 60-1, 60-2 and 60-3 (hereinafter collectively referred to as “electromagnetic-wave reflecting apparatuses 60” as appropriate) are connected to one another by frames 50. The number of electromagnetic-wave reflecting apparatuses 60 to be connected is determined as appropriate according to the environment in which they are installed.

In some cases, it is desirable that the reflecting panels 10-1, 10-2 and 10-3 (hereinafter collectively referred to as “reflecting panels 10” as appropriate) be electrically connected to one another in order to maintain the continuity of the reflection potential. When the reflection surface 105 includes a meta-surface, no electrical connection may be established between adjacent reflecting panels 10. A top frame 57 and a bottom frame 58 may be provided at the upper end and the lower end, respectively, of each of the reflecting panels 10.

When legs 56 are provided in each electromagnetic-wave reflecting apparatus 60, the legs 56 may be fixed to the installation surface with screws or the like. Alternatively, components such as casters may be attached to the legs 56 so that they can be moved. The electromagnetic-wave reflecting fence 100 may be used in combination with one electromagnetic-wave reflecting apparatus 60.

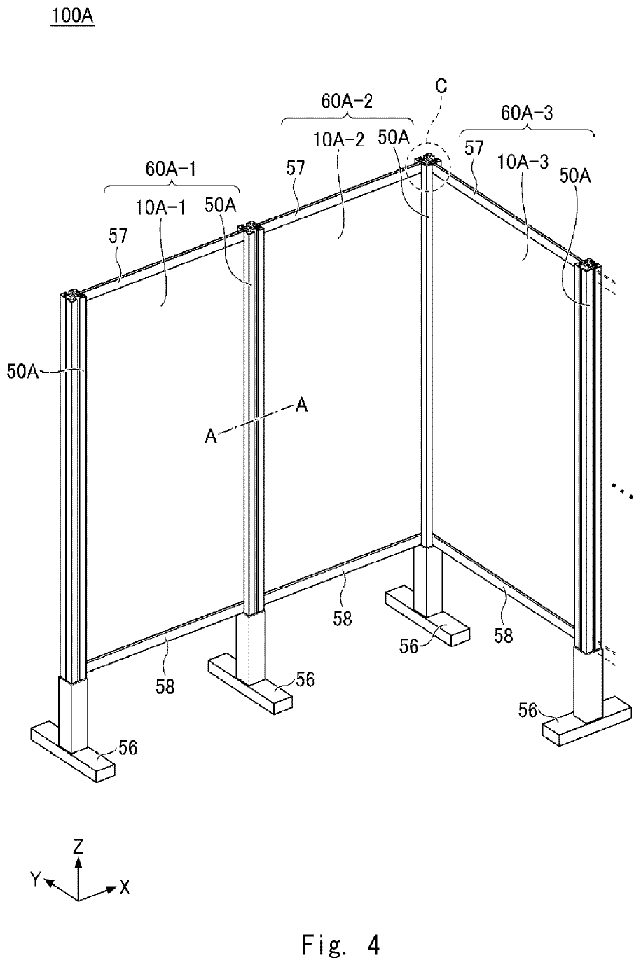

FIG. 4 is a schematic diagram of an electromagnetic-wave reflecting fence 100A as a modified example. The electromagnetic-wave reflecting fence 100A is formed by connecting electromagnetic-wave reflecting apparatuses 60A-1, 60A-2 and 60A-3 to one another. The electromagnetic-wave reflecting apparatuses 60A-1 and 60A-2 are connected to each other in the same direction (X direction in this example) by a frame 50A, and the electromagnetic-wave reflecting apparatuses 60A-2 and 60A-3 are connected to each other in different directions by another frame 50A. The upper end and the lower end of each of the reflecting panels 10A-1, 10A-2 and 10A-3 (hereinafter collectively referred to as “reflecting panels 10A” as appropriate) of the electromagnetic-wave reflecting apparatuses 60A-1, 60A-2 and 60A-3 may be held by a top frame 57 and a bottom frame 58, respectively.

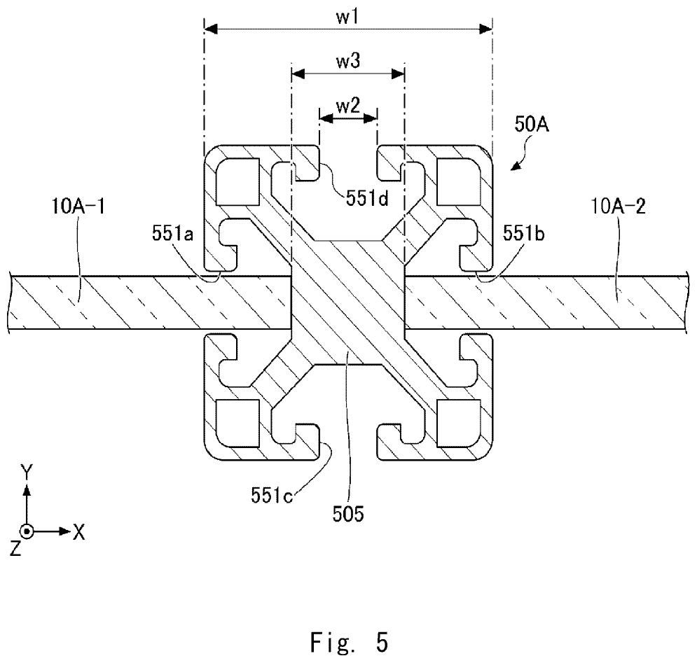

FIG. 5 is an example of a structure on a horizontal cross section of the frame 50A along a line A-A shown in FIG. 4. This horizontal cross section is a cross section in a plane parallel to the XY plane on which the electromagnetic-wave reflecting fence 100A is installed. The frame 50A includes a main body 505 formed of a conductor such as aluminum, and slits 551a, 551b, 551c and 551d (hereinafter collectively referred to as “slits 551” as appropriate) formed in the main body 505. The reflecting panels 10A-1 and 10A-2 are respectively inserted and held in the opposed slits 551a and 551b of the frame 50A. In order to reduce the weight of the frame 50A, a certain space is formed between each slit 551 and the central part of the main body 505. A cavity may be formed in the central part of the main body 505 in order to further reduce the weight. The frame 50A having the horizontal cross-sectional shape shown in FIG. 5 may be formed, for example, by injection molding.

The external shape of the horizontal cross section of the frame 50A is substantially square. The frame 50A is formed in a shape substantially symmetrical with respect to the center of the main body 505, so that it may be used in any direction. The width w1 corresponding to the length of one side of the horizontal cross section of the frame 50A is, for example, from 40 mm to 60 mm. The width w2 of each of the slits 551a to 551d is determined according to the thickness of the reflecting panel 10A to be used. The thickness w3 of the central part of the main body 505 is set in a range of 15 mm to 35 mm according to the strength required for the frame 50A. The outer surface of the frame 50A may be covered with an insulating cover such as a cover made of resin.

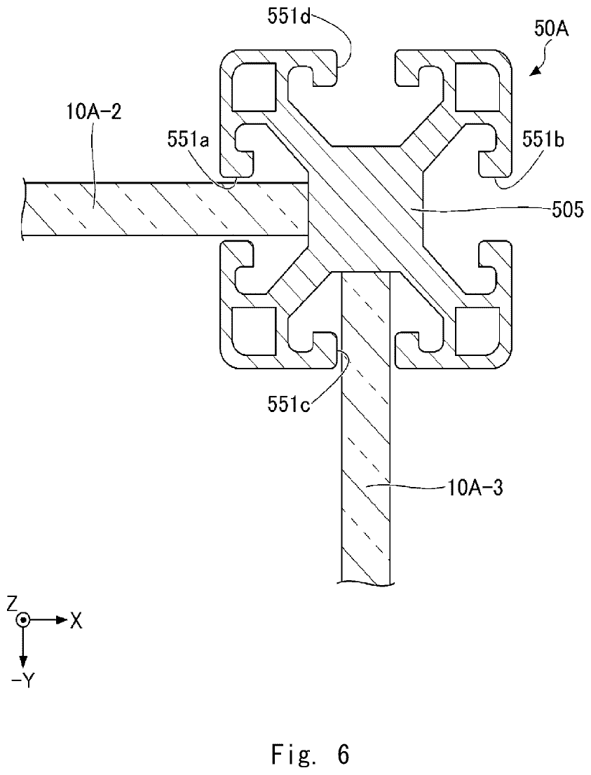

FIG. 6 is a top view of a connection part C shown in FIG. 4. The reflecting panels 10A-2 and 10A-3 are held in adjacent slits 551a and 551c, respectively, of the frame 50A, and thereby are connected to each other. The reflecting panels 10A can be connected to each other in two directions by selecting appropriate slits 551. As shown in FIG. 4, the reflecting panels 10A-1 and 10A-2 may be connected in the X direction, and the reflecting panel 10A-3 may be connected in the −Y direction. Another reflecting panel 10A may be connected to the reflecting panel 10A-3 in the −Y or −X direction. In this way, it is possible to surround a predetermined space with them and thereby to effectively suppress the emission of radio waves.

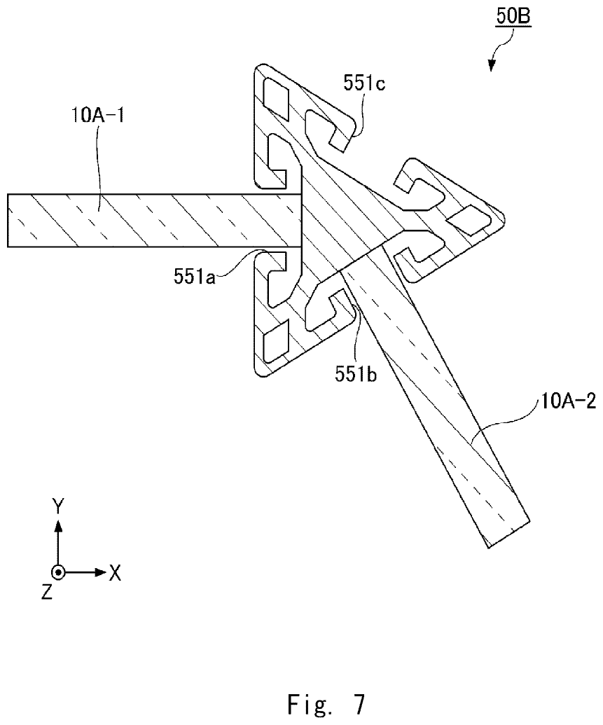

FIG. 7 shows another example of a connection of an electromagnetic-wave reflecting fence. Reflecting panels 10A-2 and 10A-3 are connected to each other by a frame 50B of which the horizontal cross section is triangular. By connecting the reflecting panels 10A by selecting two slits 551a, 551b and 551c, the reflecting panels 10A can be connected in two directions that are not orthogonal to each other. A plurality of electromagnetic-wave reflecting apparatuses 60 can be connected to one another at angles other than the parallel according to the environment in which the electromagnetic-wave reflecting fence is used and/or the positional relationship with the base station 31 and the structure 20. The triangular frame 50B can also be used to connect a reflecting panel 10C-2 to the upper end of the reflecting panel 10-1 shown in FIG. 1 C.

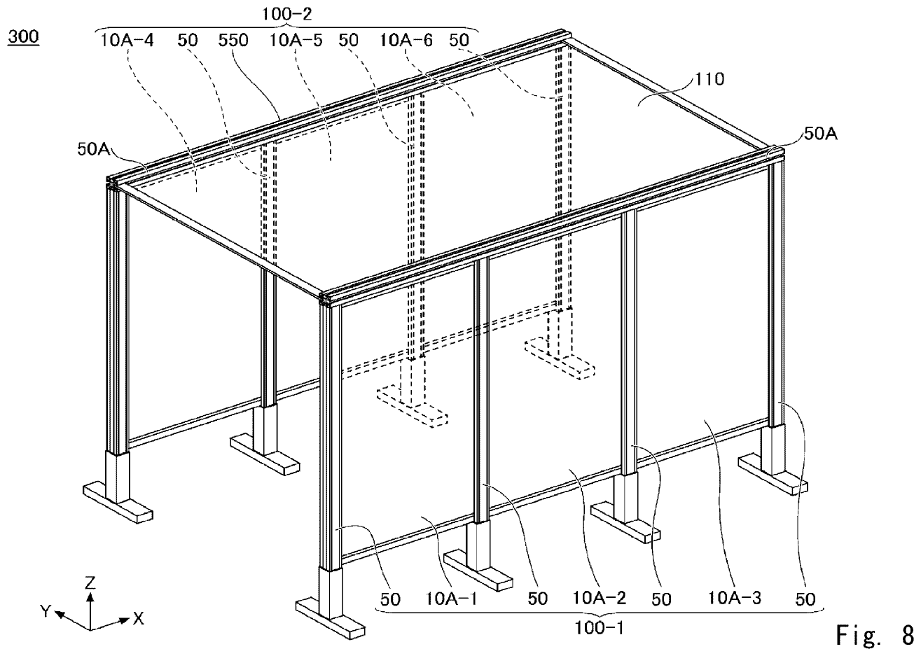

FIG. 8 shows an example of connections of an electromagnetic-wave reflecting fence 300. The electromagnetic-wave reflecting fence 300 includes a pair of two electromagnetic-wave reflecting fences 100-1 and 100-2 arranged in parallel or in a non-parallel manner, and a ceiling panel 110 covering the upper parts (i.e., a space between upper parts) of the electromagnetic-wave reflecting fences 100-1 and 100-2. In this example, the ceiling panel 110 is combined with the electromagnetic-wave reflecting fences 100-1 and 100-2 in each of which two or more electromagnetic-wave reflecting apparatuses 60 are connected to one another. However, the ceiling panel 110 may be combined with a configuration in which individual electromagnetic-wave reflecting apparatuses 60 are arranged in parallel with each other or in a non-parallel manner, or a configuration in which an electromagnetic-wave reflecting apparatus(es) 60 and an electromagnetic-wave reflecting fence(s) 100 are opposed to each other. The planar shape of the ceiling panel 110 is determined according to the direction in which the electromagnetic-wave reflecting fences 100-1 and 100-2 are arranged. Similarly to the reflecting panels 10A used in the electromagnetic-wave reflecting fences 100-1 and 100-2, the ceiling panel 110 has a reflection surface which reflects radio waves (in a predetermined band in a range of, for example, from 1 GHz to 300 GHz, or from 1 GHz to 170 GHz) emitted from a base station. The reflection surface includes at least one of a specular reflection surface and a non-specular reflection surface including a meta-surface.

In the electromagnetic-wave reflecting fence 300, the cross section of the beam of an electromagnetic wave emitted from the base station is incident on a position lower than the uppermost end of the reflection surface of the electromagnetic-wave reflecting fence 100-1 or 100-2 or on a reflection surface on the inner side of the ceiling panel 110, and is reflected downward with respect to the incident position. On the reflection surface of the ceiling panel 110, the surface facing outward, i.e., upward, is the uppermost end of the reflection surface, and the surface facing inward, i.e., downward, is the surface on which electromagnetic waves are incident. An electromagnetic wave incident on the reflection surface of the electromagnetic-wave reflecting fence 100-1 or 100-2 or on the reflection surface of the ceiling panel 110 is reflected downward with respect to the incident position, so that the emission of radio waves to the outside of the electromagnetic-wave reflecting fence 300 is suppressed. In the case where the electromagnetic-wave reflecting fence 300 is used outdoors, a protective layer having an ultraviolet protection function may be provided on the outermost layer, in particular, on the surface facing outward, of the ceiling panel 110.

In the example shown in FIG. 8, the rectangular ceiling panel 110 is used to cover the space between the electromagnetic-wave reflecting fences 100-1 and 100-2, which are opposed to each other with a predetermined distance therebetween. Either of the frames 50A shown in FIGS. 5 and 6 may be used as a top frame 57 for holding the upper end of the reflecting panel 10A. The upper end of the reflecting panel 10A may be held in the slit 551a of the frame 50A, and the edge of the ceiling panel 110 may be held by the other slit 551d adjacent to the slit 551a. By using the ceiling panel 110, the emission of radio waves scattered by a structure or the like present in the space can be effectively suppressed. The ceiling panel 110 is not limited to the flat panel disposed parallel to the installation plane (XY plane), and instead may have an arch-type curved surface.

For example, when the thickness of the reflecting panel of the ceiling panel 110 is 5.0 mm or larger and 17.0 mm or smaller, and there are few obstacles of which the heights exceed the heights of the electromagnetic-wave reflecting fences 100-1 and 100-2 in the space between the electromagnetic-wave reflecting fences 100-1 and 100-2, a ceiling panel 110 that is curved with an appropriate curvature radius may be used.

As another example of a configuration, as shown in FIG. 1B, the ceiling panel 110 may be connected to the top frame 57 by using a frame 50B having the horizontal cross-sectional shape shown in FIG. 7 while being inclined from the perpendicular line of the installation plane (XY plane). In this case, the ceiling panel 110 extends obliquely upward from the upper end of the electromagnetic-wave reflecting fence 100-1 like the reflecting panel 10-2 shown in FIG. 1B. The top end of the first ceiling panel extending obliquely upward from the upper end of the electromagnetic-wave reflecting fence 100-1 and the top end of the second ceiling panel extending obliquely upward from the upper end of the electromagnetic-wave reflecting fence 100-2 may be connected to each other by a frame 50B, and a tunnel may be thereby formed.

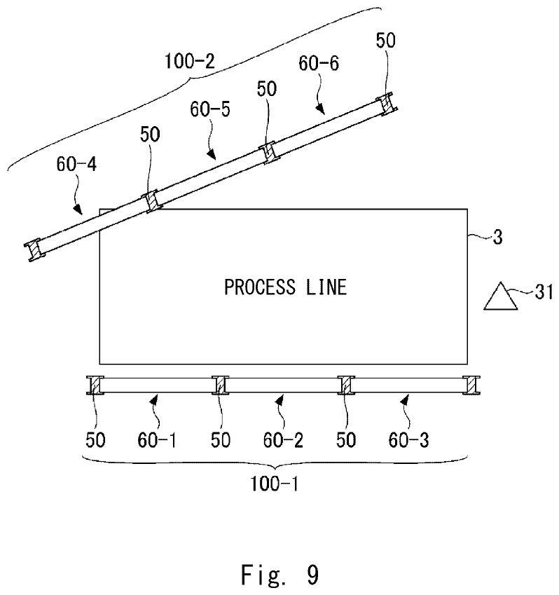

FIG. 9 is a schematic plan view showing another example of an arrangement of electromagnetic-wave reflecting fences. Electromagnetic-wave reflecting fences 100-1 and 100-2 are arranged in a non-parallel manner along a process line 3. The electromagnetic-wave reflecting fences 100-1 and 100-2 can be arranged in appropriate directions according to the arrangement of production machines inside the process line 3, the moving range, the arrangement of structures 20 which may become shielding objects (see FIGS. 1A to 1C), and the position of the base station 31. The number of electromagnetic-wave reflecting apparatuses 60 to be connected can be selected as appropriate according to the extent, i.e., the size, of the process line 3. In the case where the position of the transmitting antenna of the base station 31 is higher than the uppermost end of the electromagnetic-wave reflecting apparatus 60, the height of the electromagnetic-wave reflecting fences 100-1 and 100-2 may be selected so that an electromagnetic wave emitted from the base station 31 is incident on the reflecting panel of the electromagnetic-wave reflecting apparatus 60 in such a manner that the cross section (3 dB beam width) of the beam of the electromagnetic wave is located below the highest part of the effective reflection surface of the reflecting panel. As shown in FIG. 8, a ceiling panel 110 may be provided between the electromagnetic-wave reflecting fences 100-1 and 100-2, and thereby cover the space of the process line 3.

When the ceiling panel 110 is provided, the electromagnetic wave emitted from the base station 31 is incident on the reflection surface on the inner side of the ceiling panel 110 obliquely from below, and then is reflected toward the space between the electromagnetic-wave reflecting fences 100-1 and 100-2. By using the ceiling panel 110, the radio wave emitted from the base station 31 can be effectively reflected to the inside of the process line 3.

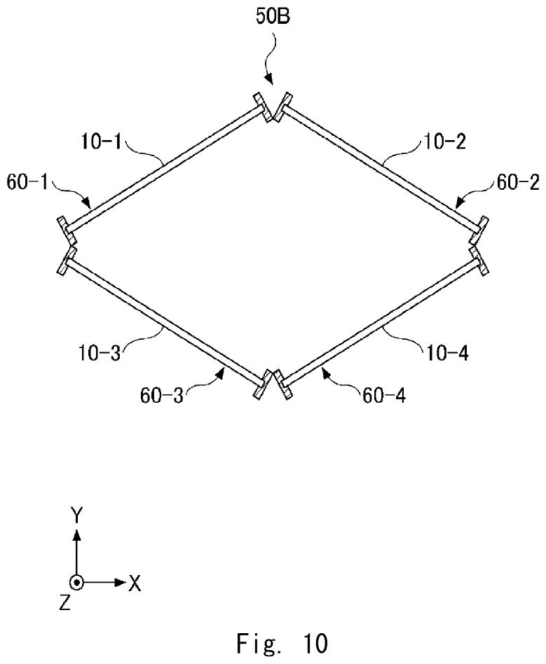

FIG. 10 is a schematic plan view showing an example of an arrangement of electromagnetic-wave reflecting apparatuses 60. Each electromagnetic-wave reflecting apparatus 60 can be individually used. For example, a predetermined area may be enclosed with electromagnetic-wave reflecting apparatuses 60-1, 60-2, 60-3 and 60-4. Four electromagnetic-wave reflecting fences 100 may be used in place of the electromagnetic-wave reflecting apparatuses 60-1 to 60-4. A ceiling panel 110 may be provided and cover the area enclosed with the four electromagnetic-wave reflecting apparatuses 60 or four electromagnetic-wave reflecting fences 100. An electromagnetic wave emitted from the base station enters the area enclosed with the electromagnetic-wave reflecting apparatuses 60 or the electromagnetic-wave reflecting fences 100. The electromagnetic wave emitted from the base station is incident on the reflection surface on the inner side of the ceiling panel 110 or at a position lower than the upper end of the reflection surface of the electromagnetic-wave reflecting apparatus 60 or the electromagnetic-wave reflecting fence, and then is reflected downward. In this way, the radio-wave environment inside the process line 3 can be improved, and the emission of radio waves to the outside of the process line 3 can be effectively suppressed.

The effectiveness of the improvement of the radio-wave environment and the effectiveness of the suppression of the emission of radio waves are checked by using a model in which a base station 31 and an electromagnetic-wave reflecting apparatus(es) 60 are installed in a facility in which a process line 3 is provided. The evaluation is made while focusing attention on the positional relationship between the height of the antenna of the base station 31 and the highest part of the reflection surface 105 of the electromagnetic-wave reflecting apparatus 60.

### Example 1

Example 1 is Implementation Example 1 (i.e., Example 1 according to the present disclosure). In a facility having a length of 50.0 m, a width of 50.0 m, and a height of 10.0 m, there are a large number of structures such as metal racks and production machines. A base station 31 (see FIG. 1A and the like) operating at a frequency of 28.2 GHz is introduced in the facility, and signals are transmitted/received between a radio terminal 34 embedded in the production machine and the base station 31. An area behind a structure 20 as viewed from the antenna of the base station 31 is a blind zone 30. An electromagnetic-wave reflecting apparatus 60 using a reflecting panel 10 having a width of 1.0 m and a height of 2.0 m is installed at a position where it can reflect a radio wave emitted from the base station 31 toward the blind zone 30. No top frame 57 and no bottom frame are used. Further, the height of the lower end of the reflecting panel 10 from the installation plane is 0.15 m, and the height of the upper end of the reflection surface 105 is 2.50 m.

The position of the antenna of the base station 31 is 3.0 m from the floor, and its maximum gain is 20 dBi. The base station 31 transmits a beam with a half width of 8° in the vertical direction and 40° in the horizontal direction obliquely downward. The electromagnetic wave emitted from the base station 31 impinges on the reflection surface 105 of the electromagnetic-wave reflecting apparatus 60 in such a manner that the cross section of the beam of the electromagnetic wave is lower than the uppermost end of the reflection surface 105, and then is reflected downward toward the blind zone 30. The received power in the blind zone 30 before the electromagnetic-wave reflecting apparatus 60 is installed is −100.0 dBm. By installing the electromagnetic-wave reflecting apparatus 60, the received power in the blind zone 30 was changed to −85.0 dBm, i.e., improved by 15.0 dB. Meanwhile, in the outside of the process line 3, the received power before the electromagnetic-wave reflecting apparatus 60 is installed is −125.0 dBm, and the received power after the installation is −125.0 dBm, i.e., is not changed.

It was confirmed that the introduction of the electromagnetic-wave reflecting apparatus 60 improved the radio-wave environment in the blind zone 30 in the process line 3, and suppressed the emission (i.e., undesired emission) of radio waves to the outside of the process line 3.

### Example 2

Example 2 is Implementation Example 2. In Example 2, the tunnel-type electromagnetic-wave reflecting fence 300 shown in FIG. 8 is used. In a facility having a length of 50.0 m, a width of 50.0 m, and a height of 10.0 m, there are a large number of structures such as metal racks and production machines. A base station 31 (see FIG. 1A and the like) operating at a frequency of 28.2 GHz is introduced in the facility, and signals are transmitted/received between a radio terminal 34 embedded in the production machine and the base station 31. An area behind a structure 20 as viewed from the antenna of the base station 31 is a blind zone 30. An electromagnetic-wave reflecting fence 300 in which electromagnetic-wave reflecting apparatuses 60 are connected to one another in a tunnel shape is constructed at a position where it can reflect a radio wave emitted from the base station 31 toward the blind zone 30.

An electromagnetic-wave reflecting fence 100-1 is manufactured by connecting four electromagnetic-wave reflecting apparatuses 60 using reflecting panels 10 each having a width of 1.0 m and a height of 2.0 m to one another by frames 50. Similarly, an electromagnetic-wave reflecting fence 100-2 is manufactured by connecting four electromagnetic-wave reflecting apparatuses 60 using reflecting panels 10 each having a width of 1.0 m and a height of 2.0 m to one another by frames 50. In a process line 3, the electromagnetic-wave reflecting fences 100-1 and 100-2 are installed with an interval of one meter therebetween, and a ceiling panel 110 is provided. When the ceiling panel 110 is connected by a frame 50A, the upper end of the reflecting panel 10 used in the electromagnetic-wave reflecting fence 100 is hidden inside the frame 50A by several millimeters, but the change to such an extent in the position of the upper end of the reflection surface 105 can be ignored.

The antenna of the base station 31 is positioned 1.5 m from the floor, and its maximum gain is 20 dBi. The base station 31 transmits a beam having a half width of 8° in the vertical direction and 40° in the horizontal direction. Inside the tunnel-type electromagnetic-wave reflecting fence 300, an area behind a structure 20 as viewed from the antenna of the base station 31 is a blind zone 30. The electromagnetic wave emitted from the base station 31 is incident on the reflection surface on the inner side of the ceiling panel 110 from below, and then is reflected downward toward the blind zone. The received power in the blind zone 30 before the electromagnetic-wave reflecting fence 300 is installed is −100.0 dBm. By installing the electromagnetic-wave reflecting fence 300, the received power in the blind zone 30 was changed to −85.0 dBm, i.e., improved by 15.0 dB. Meanwhile, in the outside of the process line 3, the received power before the electromagnetic-wave reflecting apparatus 60 is installed is −125.0 dBm, and the received power after the installation is −125.0 dBm, i.e., is not changed.

It was confirmed that by using the electromagnetic-wave reflecting fence 300 in which electromagnetic-wave reflecting apparatuses 60 are connected to one another, the radio-wave environment of the blind zone 30 in the process line 3 was improved, and the emission of radio waves to the outside of the process line 3 was suppressed.

### Example 3

Example 3 is Comparative Example 3. In Example 3, the position of the uppermost part of the beam emitted from the antenna of the base station 31 is higher than the highest part of the reflection surface 105 of the electromagnetic-wave reflecting apparatus 60. In a facility having a length of 50.0 m, a width of 50.0 m, and a height of 10.0 m, there are a large number of structures such as metal racks and production machines. A base station 31 (see FIG. 1A and the like) operating at a frequency of 28.2 GHz is introduced in the facility, and signals are transmitted/received between a radio terminal 34 embedded in the production machine and the base station 31. An area behind a structure 20 as viewed from the antenna of the base station 31 is a blind zone 30. An electromagnetic-wave reflecting apparatus 60 using a reflecting panel 10 having a width of 1.0 m and a height of 2.0 m is installed in the vicinity of the blind zone 30. No top frame 57 and no bottom frame are used. Further, the height of the lower end of the reflecting panel 10 from the installation plane is 0.15 m, and the height of the upper end of the reflection surface 105 is 2.15 m.

The position of the antenna of the base station 31 is 3.0 m from the floor, and its maximum gain is 20 dBi. The base station 31 transmits a beam having a half width of 8° in the vertical direction and 40° in the horizontal direction obliquely downward, but the uppermost part of the cross section of the beam is higher than the upper end of the electromagnetic-wave reflecting apparatus 60. The received power in the blind zone 30 before the electromagnetic-wave reflecting apparatus 60 is installed is −100.0 dBm. By installing the electromagnetic-wave reflecting apparatus 60, the received power in the blind zone 30 was changed to −85.0 dBm, i.e., improved by 15.0 dB. Meanwhile, in the outside of the process line 3, the received power before the electromagnetic-wave reflecting apparatus 60 is installed is −125.0 dBm, and the received power after the installation was changed to −90.0 dBm. This indicates that radio waves emitted from the base station 31 leak to the outside of the process line 3.

Based on the results of Examples 1 to 3, it is possible to improve the radio-wave environment in the blind zone 30 and suppress the emission of radio waves to the outside of the intended radio space by installing an electromagnetic-wave reflecting apparatus(es) 60 so that the cross section of the beam of an electromagnetic wave emitted from the antenna of the base station 31 at the 3 dB beam width is lower than the upper end of the reflection surface of the electromagnetic-wave reflecting apparatus 60. The height of the reflecting panels 10 of the electromagnetic-wave reflecting apparatus 60 may be adjusted by connecting them in the height direction according to the position where the base station 31 is installed. For example, an electromagnetic-wave reflecting apparatus 60 having a height of 3.0 m may be manufactured by connecting three reflecting panels each having a width of 2.0 m and a length of 1.0 m in the height direction.

Each of the radio transmission systems 1A to 1C according to the respective embodiments makes it possible to reduce the blind zone 30 or improve the radio-wave environment in the blind zone 30, and suppress the emission of radio waves to the outside of the intended radio space by making the electromagnetic wave emitted from the antenna of the base station 31 incident at a position lower than the upper end of the reflection surface of the electromagnetic-wave reflecting apparatus. and then reflecting the incident radio wave downward with respect to the incident position. Each of the radio transmission systems 1A to 1C according to the respective embodiments can be suitably applied to, in addition to the process line, an area extending in a certain direction such as an indoor or outdoor event venue, an ordinary road, an expressway, a railroad track, a tunnel, or the like. Further, they can also be applied to electronic toll collection systems, streets, roundabouts, terraces of commercial facilities and public facilities, arcades, and so on.

The size of the reflecting panel 10 used in the electromagnetic-wave reflecting apparatus 60 can be designed as appropriate according to the situation in which the electromagnetic-wave reflecting apparatus 60 is used. As an example, the size may be from 10 cm×10 cm to 4.0 m×4.0 m. It is sufficient if the height of the antenna of the base station 31 is lower than the uppermost end of the reflection surface 105 of the electromagnetic-wave reflecting apparatus 60. The height, the orientation, and the assembly method of the electromagnetic-wave reflecting apparatus(es) 60 are designed as appropriate according to the position of the transmitting antenna of the base station introduced in the environment in which the electromagnetic-wave reflecting apparatus(es) 60 is placed. The reflection surface 105 of the electromagnetic-wave reflecting apparatus 60 reflects the incident electromagnetic wave downward with respect to the incident position of the electromagnetic wave. As a result, the blind zone 30 is reduced, and the emission of radio waves from the predetermined space is suppressed.

Embodiments according to the present disclosure have been described above, and the present disclosure may include configurations described hereinafter.

### (Item 1)

A radio transmission system comprising:
a base station configured to perform radio communication in a predetermined frequency band selected from frequencies from 1 GHz to 300 GHz; and
an electromagnetic-wave reflecting apparatus disposed in a communication area of the base station and including a reflecting panel configured to reflect an electromagnetic wave in the predetermined frequency band, wherein
the electromagnetic wave emitted from the base station impinges at a position lower than a position of an uppermost portion of a reflection surface of the reflecting panel, and
the electromagnetic-wave reflecting apparatus reflects the electromagnetic wave incident on the reflecting panel downward with respect to the incident position.

### (Item 2)

The radio transmission system described in Item 1, wherein the reflecting panel includes a non-specular reflection surface and reflects the electromagnetic wave incident on the reflecting panel downward at an angle different from an incident angle.

### (Item 3)

The radio transmission system described in Item 1 or 2, wherein the reflecting panel includes a specular reflection surface and reflects the electromagnetic wave incident on the reflecting panel downward at an angle equal to an incident angle.

### (Item 4)

The radio transmission system described in Item 1, wherein
the electromagnetic-wave reflecting apparatus includes a first reflecting panel standing substantially perpendicular to an installation plane, and a second reflecting panel connected to an upper end of the first reflecting panel, and
the second reflecting panel is inclined from a perpendicular line of the installation plane.

### (Item 5)

The radio transmission system described in Item 4, wherein each of a first reflection surface of the first reflecting panel and a second reflection surface of the second reflecting panel includes a specular reflection surface in at least a part thereof.

### (Item 6)

The radio transmission system described in any one of Items 1 to 5, further comprising:
at least two electromagnetic-wave reflecting apparatuses opposed to each other in parallel or in a non-parallel manner; and
a ceiling panel covering a space between the at least two electromagnetic-wave reflecting apparatuses, wherein
the electromagnetic wave emitted from the base station is incident at a position lower than an uppermost part of the reflection surface of the at least two electromagnetic-wave reflecting apparatuses or incident on a reflection surface on an inner side of the ceiling panel, and then is reflected downward with respect to the incident position.

### (Item 7)

The radio transmission system described in Item 6, wherein the reflection surface on the inner side of the ceiling panel is parallel to an installation plane of the at least two electromagnetic-wave reflecting apparatuses.

### (Item 8)

The radio transmission system described in Item 6, wherein the reflection surface on the inner side of the ceiling panel is inclined with respect to an installation plane of the at least two electromagnetic-wave reflecting apparatuses.

### (Item 9)

The radio transmission system described in any one of Items 1 to 8, wherein an electromagnetic-wave reflecting fence is formed by connecting a plurality of electromagnetic-wave reflecting apparatuses to one another.

### (Item 10)

The radio transmission system described in any one of Items 1 to 8, wherein a first electromagnetic-wave reflecting fence to which the plurality of electromagnetic-wave reflecting apparatuses are connected and a second electromagnetic-wave reflecting fence to which the plurality of electromagnetic-wave reflecting apparatuses are connected are arranged in parallel or in a non-parallel manner.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A radio transmission system comprising:
a base station configured to perform radio communication in a predetermined frequency band selected from frequencies from 1 GHz to 300 GHz; and
an electromagnetic-wave reflecting apparatus disposed in a communication area of the base station and including a reflecting panel configured to reflect an electromagnetic wave in the predetermined frequency band, wherein
the electromagnetic wave emitted from the base station impinges at a position lower than a position of an uppermost portion of a reflection surface of the reflecting panel, and
the electromagnetic-wave reflecting apparatus reflects the electromagnetic wave incident on the reflecting panel downward with respect to the incident position.

2. The radio transmission system according to claim 1, wherein the reflecting panel includes a non-specular reflection surface and reflects the electromagnetic wave incident on the reflecting panel downward at an angle different from an incident angle.

3. The radio transmission system according to claim 1, wherein the reflecting panel includes a specular reflection surface and reflects the electromagnetic wave incident on the reflecting panel downward at an angle equal to an incident angle.

4. The radio transmission system according to claim 1, wherein
the electromagnetic-wave reflecting apparatus includes a first reflecting panel standing substantially perpendicular to an installation plane, and a second reflecting panel connected to an upper end of the first reflecting panel, and
the second reflecting panel is inclined from a perpendicular line of the installation plane.

5. The radio transmission system according to claim 4, wherein each of a first reflection surface of the first reflecting panel and a second reflection surface of the second reflecting panel includes a specular reflection surface in at least a part thereof.

6. The radio transmission system according to claim 1, further comprising:
at least two electromagnetic-wave reflecting apparatuses opposed to each other in parallel or in a non-parallel manner; and
a ceiling panel covering a space between the at least two electromagnetic-wave reflecting apparatuses, wherein
the electromagnetic wave emitted from the base station is incident at a position lower than an uppermost part of the reflection surface of the at least two electromagnetic-wave reflecting apparatuses or incident on a reflection surface on an inner side of the ceiling panel, and then is reflected downward with respect to the incident position.

7. The radio transmission system according to claim 6, wherein the reflection surface on the inner side of the ceiling panel is parallel to an installation plane of the at least two electromagnetic-wave reflecting apparatuses.

8. The radio transmission system according to claim 6, wherein the reflection surface on the inner side of the ceiling panel is inclined with respect to an installation plane of the at least two electromagnetic-wave reflecting apparatuses.

9. The radio transmission system according to claim 1, wherein an electromagnetic-wave reflecting fence is formed by connecting a plurality of electromagnetic-wave reflecting apparatuses to one another.

10. The radio transmission system according to claim 1, wherein a first electromagnetic-wave reflecting fence to which the plurality of electromagnetic-wave reflecting apparatuses are connected and a second electromagnetic-wave reflecting fence to which the plurality of electromagnetic-wave reflecting apparatuses are connected are arranged in parallel or in a non-parallel manner.
